(19) United States
(12) Patent Application Publication
(10) Pub. No.: US 2021/0149018 A1
(43) Pub. Date: May 20, 2021

(54) MINIMIZING PHASE NOISE IN FMCW RADAR AND DETECTING RADAR HOUSING COATING

(71) Applicant: SEMICONDUCTOR COMPONENTS INDUSTRIES, LLC, Phoenix, AZ (US)

(72) Inventors: Danny ELAD, Kibutz Matzuva (IL); Oded KATZ, Ganei-Tikva (IL)

(73) Assignee: SEMICONDUCTOR COMPONENTS INDUSTRIES, LLC, Phoenix, AZ (US)

(21) Appl. No.: 16/686,773

(22) Filed: Nov. 18, 2019

(51) Int. Cl. G01S 7/35

(52) U.S. Cl. CPC G01S 7/354; G01S 2007/027; G01S 2007/358

(57) ABSTRACT

One illustrative embodiment of a radar system includes: a signal generator, a variable phase shifter element, and a mixer. The signal generator supplies a frequency modulated continuous wave (FMCW) signal to a transmit antenna protected by a housing, which causes a housing reflection having a frequency offset from the FMCW signal. The variable phase shifter element derives a reference signal from the FMCW signal by applying a time-dependent phase shift based on the frequency offset. The mixer obtains a receive signal including said housing reflection and multiplies the receive signal with the reference signal to produce a downconverted signal.

### BACKGROUND

In the quest for ever-safer and more convenient transportation options, many car manufacturers are developing self-driving cars which require an impressive number and variety of sensors. Among the contemplated sensing technologies are multi-input, multi-output radar systems to monitor the distances between the car and any vehicles or obstacles along the travel path. The radar system antennas are expected to operate from within a vehicle bumper or other housing that provides protection, but which may also cause the closest and strongest reflection of signal energy. Accumulations of dirt, mud, and/or ice on the housing can increase the reflection but also reduce the RADAR transmission power through the housing, thus degrading the ability of the radar system to detect obstacles. In any event, the reduced transmission through the RADAR housing may reduce the dynamic range of the detection signal, degrading signal-to-noise ratio (SNR) and thereby reducing accuracy of range and velocity measurements.

### SUMMARY

The problems identified above may be addressed at least in part by employing a radar-housing tone discriminator in frequency-modulated continuous wave (FMCW) radar systems. One illustrative embodiment of a radar system includes: a signal generator, a variable phase shifter element, and a mixer. The signal generator supplies a frequency modulated continuous wave (FMCW) signal to a transmit antenna protected by a housing, which causes a housing reflection having a frequency offset from the FMCW signal. The variable phase shifter element derives a reference signal from the FMCW signal by applying a time-dependent phase shift based on the frequency offset. The mixer obtains a receive signal including said housing reflection and multiplies the receive signal with the reference signal to produce a downconverted signal.

One illustrative embodiment of a radar signal downconversion method includes: supplying a frequency modulated continuous wave (FMCW) signal to a transmit antenna protected by a housing, which causes a housing reflection having a frequency offset from the FMCW signal; derives a reference signal from the FMCW signal by applying a time-dependent phase shift based on the frequency offset; and multiplying the reference signal with a receive signal including said housing reflection to produce a downconverted signal.

An alternative radar system embodiment includes: a signal generator, a mixer, and an analog-to-digital converter. The signal generator supplies a FMCW signal to a transmit antenna protected by a housing, which causes a housing reflection having a frequency offset from the FMCW signal. The mixer derives a downconverted signal from a receive signal including said housing reflection. The amplitude of the housing reflection can be determined from the downconverted signal.

Each of the foregoing embodiments can be employed individually or in conjunction, and may include one or more of the following features in any suitable combination: 1. a controller that adjusts the time-dependent phase shift to minimize phase noise in the downconverted signal. 2. a controller that adjusts the time-dependent phase shift to maximize a DC component of the downconverted signal. 3. An ADC that determines an amplitude of the housing reflection from the downconverted signal. 4. a safety engine that signals an error condition if the housing reflection exceeds a predetermined threshold. 5. the variable phase shifter element derives a reference signal from the FMCW signal, which the mixer uses to produce a downconverted signal. 6. a controller that applies a phase rotation to the reference signal to obtain an in-phase product signal with a minimum phase noise or maximum DC component, and a quadrature phase product signal with a maximum phase noise or minimum DC component. 7. a high-pass filter having a cutoff frequency below which low frequency components of the downconverted signal are attenuated. 8. the mixer multiplies the receive signal by a reference signal that shifts the offset frequency to or above the high pass filter cutoff frequency. 9. a processor that determines the amplitude of the housing reflection from phase noise in the downconverted signal near the cutoff frequency. 10. the mixer multiplies the receive signal by an in-phase reference signal or a quadrature-phase reference signal to produce the downconverted signal.

### BRIEF DESCRIPTION OF THE DRAWINGS

FIG. 1 is an overhead view of an illustrative vehicle equipped with sensors.

FIG. 2 is a block diagram of an illustrative driver-assistance system.

FIG. 3 is a block diagram of an illustrative radar transceiver chip.

FIG. 4 is a schematic view of an illustrative radar detection operation.

FIG. 5 is a schematic of a first illustrative frequency-modulated continuous wave (FMCW) radar system embodiment.

FIG. 6 is a schematic of a second illustrative FMCW radar system embodiment.

### DETAILED DESCRIPTION

It should be understood that the following description and accompanying drawings are provided for explanatory purposes, not to limit the disclosure. To the contrary, they provide the foundation for one of ordinary skill in the art to understand all modifications, equivalents, and alternatives falling within the scope of the claims.

FIG. 1 shows an illustrative vehicle 102 equipped with a set of ultrasonic parking-assist sensors 104 and a radar antenna array 106. The type, number, and configuration of sensors in the sensor arrangement for vehicles having driver-assist and self-driving features varies. For example, at least some contemplated radar arrays for autonomous vehicles include four transmit antennas and eight or more receive antennas arranged to scan along and to the sides of the vehicle's forward travel path. The vehicle may employ the sensor arrangement for detecting and measuring distances/directions to objects in the various detection zones to enable the vehicle to navigate while avoiding other vehicles and obstacles.

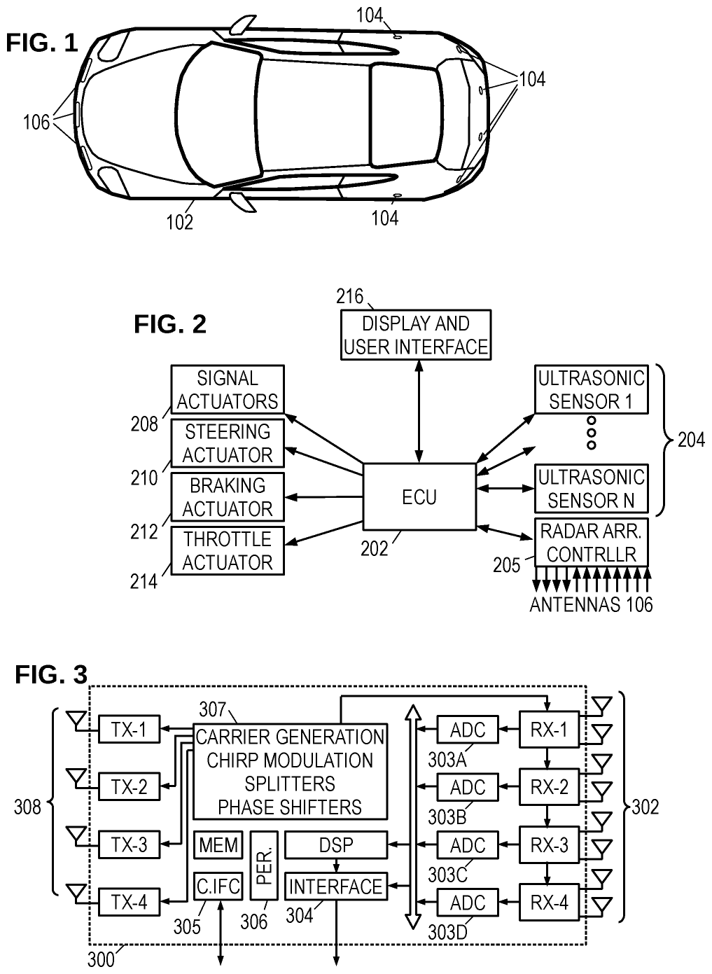

FIG. 2 shows an electronic control unit (ECU) 202 coupled to the various ultrasonic sensors 204 and a radar array controller 205 as the center of a star topology. Of course, other topologies including serial, parallel, and hierarchical (tree) topologies, are also suitable and are contemplated for use in accordance with the principles disclosed herein. The radar array controller 205 couples to the transmit and receive antennas in the radar antenna array 106 to transmit electromagnetic waves, receive reflections, and determine a spatial relationship of the vehicle to its surroundings. To provide automated parking assistance, the ECU 202 may further connect to a set of actuators such as a turn-signal actuator 208, a steering actuator 210, a braking actuator 212, and throttle actuator 214. ECU 202 may further couple to a user-interactive interface 216 to accept user input and provide a display of the various measurements and system status.

Using the interface, sensors, and actuators, ECU 202 may provide automated parking, assisted parking, lane following, lane-change assistance, obstacle and blind-spot detection, adaptive cruise-control, automated braking, autonomous driving, and other desirable features. In an automobile, the various sensor measurements are acquired by one or more electronic control units (ECU), and may be used by the ECU to determine the automobile's status. The ECU may further act on the status and incoming information to actuate various signaling and control transducers to adjust and maintain the automobile's operation.

To gather the necessary measurements, the ECU may employ, e.g., a constant frequency continuous wave (CW) or a frequency-modulated continuous wave (FMCW) radar system. Radar systems operate by emitting electromagnetic waves which travel outward from the transmit antenna before being reflected back to a receive antenna. The reflector can be any moderately reflective object in the path of the emitted electromagnetic waves. By measuring the travel time of the electromagnetic waves from the transmit antenna to the reflector and back to the receive antenna, the radar system can determine the distance to the reflector. For FMCW radar, the transmit signal frequency changes over time (chirp) and the target distance will be proportional to the frequency difference between the receive signal and the reference signal, which is the mixer out frequency. If multiple transmit or receive antennas are used, or if multiple measurements are made at different positions, the radar system can determine the direction to the reflector and hence track the location of the reflector relative to the vehicle. With more sophisticated processing, multiple reflectors can be tracked. At least some radar systems employ array processing to “scan” a directional beam of electromagnetic waves and construct an image of the vehicle's surroundings.

FIG. 3 shows a block diagram of an illustrative transceiver chip 300 for a radar system. It includes 4 receivers (RX-1 through RX-4) each of which is selectably coupled to two receive antennas 302, providing a reconfigurable MIMO system with 8 receive antennas, four of which can be employed concurrently to collect measurements. Four ADCs 303A-303D sample and digitize the downconverted receive signals from the receivers RX-1 through RX-4, supplying the digitized signals to a digital signal processor (DSP) for filtering and processing, or directly to a high-bandwidth interface 304 to enable off-chip processing of the digitized baseband signals. If used, the DSP generates image data that can be conveyed to an ECU via the high-bandwidth interface 304.

A control interface 305 enables the ECU or other host processor to configure the operation of the transceiver chip 300, including the test and calibration peripheral circuits 306 and the transmit signal generation circuitry 307. Circuitry 307 generates a carrier signal within a programmable frequency band, with a programmable chirp rate and range. Splitters and phase shifters enable the multiple transmitters TX-1 through TX-4 to operate concurrently if desired, and further provide a reference “local oscillator” signal to the receivers for use in the downconversion process. In the illustrated example, the transceiver chip 300 includes 4 transmitters (TX-1 through TX-4) each of which is fixedly coupled to a corresponding transmit antenna 308. In alternative embodiments, multiple transmit antennas are selectably coupled to each of the transmitters.

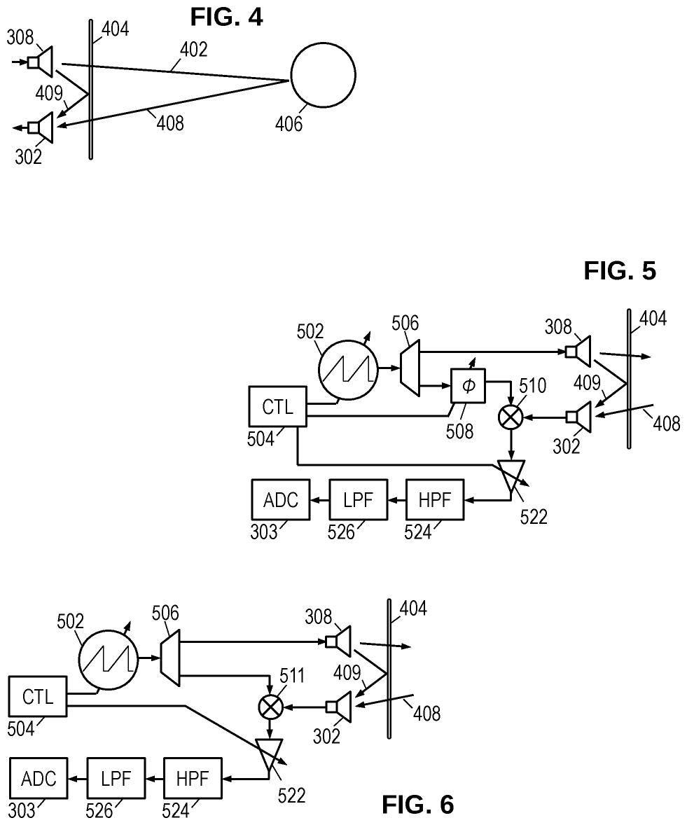

FIG. 4 illustrates operation of the radar system. A transmit antenna 308 transmits an FMCW signal 402, which for automotive radar may be in the W band (75 GHz-110 GHz), though other frequency ranges can also be employed. For the current analysis, the FMCW signal is taken to be a “chirp” signal with a frequency that repeatedly sweeps linearly across the chosen frequency band, but other frequency modulation techniques may also be suitable. For the moment, we represent the transmit signal 402 as

X_{T}(t)=cos(ω_{c}t+φₙ(t),

neglecting the frequency modulation. The (angular) carrier frequency is ω_{c}, the phase noise is φₙ(t), and time is represented by t. The phase noise in the transmit signal may arise from various internal and environmental causes.

The transmit signal 402 passes through the radar housing (e.g. radome), which may be a bumper or other protective housing, 404 to encounter an obstacle 406, from which it returns to the receive antenna 302 as a reflection 408. The radar housing 404 also causes a reflection 409 to return to the receive antenna 302. The reflection is the closest and often the strongest reflection. The receive antenna signal can accordingly be represented as

X_{R}(t)=A_{B} COS[(ω_{c}+ω_{B})(t−t_{dB})+φₙ(t−t_{dB})]+A_{T} COS[(ω_{c}+ω_{T})(t−t_{dT})+φₙ(t−t_{dT})]

where A_{B} and A_{T} are the amplitudes of the radar housing reflection and target reflection, respectively, t_{dB} and t_{dT} are their round trip travel times, and ω_{B} and ω_{T} are the frequency offsets from the current carrier frequency resulting from the travel time delays.

FIG. 5 shows a receiver using a frequency discriminator arrangement for downconverting the receive antenna signal. A signal generator 502, operating under control of a controller 504, generates an FMCW transmit signal. (Controller 504 may be embodied as the DSP in FIG. 3.) In FIG. 5, the generator 502 is shown as being configured to provide a transmit signal with its frequency modulated in accordance with a rising sawtooth chirp function (can also be employed with a falling sawtooth chirp function or a triangular chirp function). A splitter 506 splits the transmit signal between the transmit antenna 308 and the reference signal path with an adjustable phase shifter element 508. The phase shifter element 508 controls the relative phase change of the reference signal. (The reference signal may also be referred to as a “local oscillator” signal or “LO” signal”.) The reference signals can be represented as

X_{LO}(t)=cos(ω_{c}t+φₙ(t)+ϕ₀)

where ϕ₀ is the phase shift, which differs by

$$\frac{π}{2}$$

for the two reference signals.

The mixer 510 multiplies the receive antenna signal by the reference signal to obtain the downconverted (“intermediate frequency”) signal:

Y_{IF}(t)=LPF{X_{R}(t)X_{LO}(t)}

where LPF{ } is a low-pass filter operation that blocks the upconverted frequency component and serves as an anti-aliasing filter that blocks any tones above the ADC Nyquist frequency. A variable gain amplifier 522 operates using a gain setting from the controller 504 to provide automatic gain control for the mixer output. One or more filters 524, 526, may provide the LPF operation above as well as a high-pass filtering operation to block any undesired low frequency components prior to digitization by the ADC 303.

In the absence of any other targets, the result is just the radar housing tone with phase offsets due to travel time and phase noise

Y_{IF}(t)=A_{B} COS[(ω_{c}+ω_{B})t_{dB}+ω_{B}t+φₙ(t−t_{dB})−φₙ(t)+ϕ₀]

As the housing is on the order of 4 cm away, t_{dB} is expected to be well within the coherence period of the phase noise, such that φₙ(t−t_{dB})−φₙ(t)<<π. Because the housing position is known, the frequency offset ω_{B} can be determined from the programmed sweep rate of the FMCW signal.

Before proceeding further with the analysis relating to the operation of phase shifter element 508, we pause here to note that the high pass filter 524 shown in FIG. 5 is included to block low frequencies including the radar housing tone frequency ω_{B}, as the radar housing is typically not regarded as a valid target and the reflection might otherwise be strong enough to saturate the receiver. In a first contemplated embodiment of a technique for detecting radar housing reflectivity changes, the high pass filter 524 may be entirely or selectably omitted, or may be modified to lower its cutoff frequency below that of the radar housing tone frequency, and the dynamic range of the receive chain may be modified to enable the radar housing tone to be detected by the ADC 303. The signal amplitude at the radar housing tone frequency indicates the radar housing reflectivity and may be monitored to detect changes indicative of mud, snow, or other coatings.

In a second contemplated embodiment of a technique for detecting radar housing reflectivity changes, rather than monitoring the radar housing tone frequency, the controller causes the signal generator 502 to generate a constant frequency CW signal, thereby eliminating any frequency offset in the receive signal. The downconverted signal from the mixer 510 is then essentially a DC signal with an amplitude which may be determined by, or at least dominated by, the reflection from the radar housing. The high pass filter is entirely or selectably omitted to enable the DC signal measurement by the ADC 303.

With regard to the first and second contemplated embodiments discussed above, the phase shifter element 508 is optional and may be omitted or bypassed for the reflectivity monitoring. Returning now to the analysis regarding the operation of the phase shifter element, we demonstrate potential advantages to its inclusion.

If we use the phase shifter element to provide a phase shift of:

$${φ}_{0} = - {ω}_{B} t - ( {ω}_{c} + {ω}_{B} ) {t}_{dB} + \frac{π}{2} ,$$

then

Y_{IF}(t)≈A_{B}t_{dB}\dot{φ}ₙ(t)≈A_{B}φₙ(t).

On the other hand, if the phase shifter instead provides a phase shift of:

ϕ₀=−ω_{B}t−(ω_{c}+ω_{B})t_{dB},

then

Y_{IF}(t)=A_{B} COS[Φₙ(t−t_{dB})−φₙ(t)]≈A_{B}

Stated in words, if the controller 504 modulates the phase shift provided by element 508 using the housing tone plus a constant phase component (which equals to the product between the round trip travel time to the radar housing tone plus the carrier tone), the housing tone is suppressed from the downconverted signal, leaving (in the absence of an obstacle) only a DC component approximately proportional to the amplitude of the radar housing reflection 409. If instead the controller 504 modulates the phase shift provided by element 508 using the radar housing tone, a constant quadrature component, and the constant phase component above (which equals to the product between the round trip travel time to the radar housing tone plus the carrier tone), the housing tone is suppressed from the downconverted signal, leaving only an approximation of the product between the radar housing reflection amplitude and the phase noise φₙ(t).

Extending this analysis to the situation where there is at least one target reflection in the antenna receive signal, the downconverted signal becomes:

Y_{IF}(t)=A_{B} COS[(ω_{c}+ω_{B})t_{dB}+ω_{B}t+φₙ(t−t_{dB})−φₙ(t)+ϕ₀]+A_{T} COS[(ω_{c}+ω_{T})t_{dT}+ω_{T}t+φₙ(t−t_{dT})−φₙ(t)+ϕ₀]

For the quadrature phase shift,

Y_{IF}(t)≈A_{B}φₙ(t)+A_{T} COS[(ω_{T}−ω_{B})t+φₙ(t−t_{dT})−φₙ(t)],

(neglecting a constant phase term (ω_{c}+ω_{T})(t_{dT}−t_{dB})), and for the in-phase shift,

Y_{IF}(t)≈A_{B}+A_{T} COS[(ω_{T}−ω_{B})t+φₙ(t−t_{dT})−φₙ(t)].

In other words, the downconverted signal with the constant quadrature phase component of the reference signal has the phase noise from the radar housing tone converted into an amplitude-modulated noise source, degrading the amplitude SNR, whereas the downconverted signal with the constant in-phase component of the reference signal includes only a DC component equal to the amplitude of the radar housing tone reflection, making it the preferred setup for analysis to detect obstacle reflections and determine associated distances and velocities. Conversely, adding the quadrature phase component to the reference signal is the preferred setup for characterizing the phase noise.

In practice, additional phase shift between the receive and reference signals may accumulate due to contributions from components along the transmit and receive paths, and may vary based upon age or environmental effects. The controller 504 may adapt the constant component of the phase shifter element 508 to minimize phase noise in the downconverted signal, or alternatively to maximize amplitude noise of the DC component of the downconverted signal. Alternatively, the DSP may capture both in-phase and quadrature-phase contributions and apply an adaptive phase rotation with the same optimization metric. Thus the use of a variable phase shifter element 508 to suppress the radar housing tone enables at least these three contemplated embodiments of a technique for minimizing the effect of phase noise. The residual phase noise in the target reflection is expected to be uncorrelated with the reference signal phase noise, but we can generalize the above embodiments to uncorrelated phase from target reflection noise under the assumptions that: φₙ(t−t_{dT})−ₙ(t)<<π

In addition to providing a way to improve SNR and to characterize phase noise, the receiver of FIG. 5 further provides a third contemplated embodiment of a technique for detecting radar housing reflectivity changes. The amplitude of the radar housing reflection A_{B} can be monitored using the DC component of the downconverted signal when a constant in-phase component of the reference signal is applied and/or the variance of the downconverted signal when the constant quadrature component of the reference signal is applied. As previously mentioned, accumulation of dirt, mud, or ice, on the bumper may affect the reflectivity of the housing and impair the ability of the radar signal energy to penetrate. The firmware executed by the DSP may include a safety state machine or safety engine that monitors the radar housing reflection amplitude and, if the amplitude increases above a predetermined threshold, may alert the ECU, enabling the ECU to alert the driver to the issue. (Alternatively the safety engine may be implemented using application specific hardware that operates in parallel with the DSP.) An informed driver can clear the dirt, mud, ice, or other impairment from the radar housing to restore proper operation of the system.

As previously noted, some radar system embodiments may high-pass filter the downconverted signal to remove DC and attenuate other low frequency components typically associated with reflections from the housing and other nearby surfaces not intended to be measured by the radar system. If such filtering is employed where it is nevertheless desirable to monitor the radar housing reflectivity, the reference signal may be modified by the phase shifter element 508 to shift the radar housing tone to a frequency ω₀ above the cutoff frequency of the high-pass filter by applying a linear time dependent phase shift of ω₀t. Thus, in a fourth contemplated embodiment of a technique for detecting radar housing reflectivity changes, element 508 may provide a variable phase shift of

ϕ₀=(ω₀)t−(ω_{c}+(ω_{B})t_{dB},

and the DSP may then be configured to measure signal energy at frequency ω₀.

In a fifth contemplated embodiment of a technique for detecting radar housing reflectivity changes, the high-pass filter may be permitted to block the low frequency or DC component representing the peak of the radar housing reflection signal, with the recognition that the phase noise φₙ(t) extends over a significant frequency band and is expected to include components that would pass through the high-pass filter, perhaps with an acceptable degree of attenuation. Thus when the constant quadrature component of the reference signal is applied the downconverted signal would still include information about the amplitude of the radar housing reflection.

FIG. 6 shows an alternative receiver embodiment in which the phase shifter element is omitted, such that mixer 511 multiplies the receive antenna signal by an essentially undelayed version of the transmit signal. The variable gain amplifier 522 operates under control of controller 504 to optimize the dynamic range of the signal at the input to ADC 303. The output of the variable gain amplifier 522 is filtered by a high-pass filter 524 and a low-pass filter 526 (not necessarily in that order) to provide a downconverted signal for digitization by ADC 303.

This receiver embodiment is suitable for implementing at least the first, second, and fifth contemplated embodiments of a technique for detecting radar housing reflectivity changes as previously described. Because this receiver embodiment does not modulate the phase shifter to drive the radar housing tone to DC, the downconverted signal may be represented as:

Y_{IF}(t)=A_{B} COS[(ω_{c}+CO_{B})t_{dB}+ω_{B}t]+A_{T} COS[(ω_{c}+CO_{T})t_{dT}+ω_{T}t],

where phase noise is neglected. To enable the DSP to monitor of the radar housing reflection amplitude A_{B}, the high-pass filter may be omitted or its cutoff frequency set below that of the expected radar housing tone ω_{B}. Note, however, that this embodiment lacks the radar housing tone phase-noise suppression provided by at least some of the previously described embodiments.

Numerous other modifications, equivalents, and alternatives, will become apparent to those of ordinary skill in the art once the above disclosure is fully appreciated. It is intended that the following claims be interpreted to embrace all such modifications, equivalents, and alternatives where applicable.

What is claimed is:

1. A radar system that comprises:
a signal generator that supplies a frequency modulated continuous wave (FMCW) signal to a transmit antenna protected by a housing, the housing causing a housing reflection having a frequency offset from the FMCW signal;
a variable phase shifter element that derives a reference signal from the FMCW signal by applying a time-dependent phase shift based on the frequency offset; and
a mixer that obtains a receive signal including said housing reflection and multiplies the receive signal with the reference signal to produce a downconverted signal.

2. The radar system of claim 1, further comprising a controller that adjusts the time-dependent phase shift to minimize phase noise in the downconverted signal.

3. The radar system of claim 1, further comprising a controller that adjusts the time-dependent phase shift to convert a phase noise component to amplitude noise that is maximized on a DC component of at the downconverted signal.

4. The radar system of claim 1, further comprising a controller that determines an amplitude of the housing reflection from the downconverted signal.

5. The radar system of claim 4, wherein the controller signals an error condition if the housing reflection exceeds a predetermined threshold.

6. The radar system of claim 1, wherein the variable phase shifter element further derives a time variant phase shifted reference signal from the FMCW signal, which the mixer uses to produce a downconverted signal.

7. The radar system of claim 6, further comprising a controller that applies a phase shift to the reference signal to obtain a downconverted signal with either a minimum phase noise or with a phase noise that is converted to amplitude noise which is maximized on a DC component of the downconverted signal.

8. A radar system that comprises:
a signal generator that supplies a FMCW signal to a transmit antenna protected by a housing, the housing causing a housing reflection having a frequency offset from the FMCW signal;
a mixer that derives a downconverted signal from a receive signal including said housing reflection; and
an analog to digital converter that digitizes the downconverted signal; and
a controller that monitors an amplitude of the housing reflection from the downconverted signal.

9. The radar system of claim 8, wherein the controller signals an error condition if the housing reflection exceeds a predetermined threshold.

10. The radar system of claim 8, further comprising: a high-pass filter having a cutoff frequency below which low frequency components of the downconverted signal are attenuated.

11. The radar system of claim 10, wherein the mixer multiplies the receive signal by a reference signal that shifts the offset frequency to or above the cutoff frequency.

12. The radar system of claim 10, wherein the controller monitors the amplitude of the housing reflection based on phase noise in the downconverted signal near the cutoff frequency.

13. The radar system of claim 10, wherein the mixer multiplies the receive signal by a quadrature-phase reference signal to produce the downconverted signal, and wherein the controller monitors the amplitude of the housing reflection based on phase noise in the downconverted signal.

14. A radar signal downconversion method that comprises:
supplying a frequency modulated continuous wave (FMCW) signal to a transmit antenna protected by a housing, the housing causing a housing reflection having a frequency offset from the FMCW signal;
derives a reference signal from the FMCW signal by applying a time-dependent phase shift based on the frequency offset; and
multiplying the reference signal with a receive signal including said housing reflection to produce a downconverted signal.

15. The method of claim 14, further comprising: adjusting the time-dependent phase shift to minimize phase noise in the downconverted signal.

16. The method of claim 14, further comprising: adjusting the time-dependent phase shift to maximize a DC component of the downconverted signal.

17. The method of claim 14, further comprising: determining an amplitude of the housing reflection from the downconverted signal.

18. The method of claim 17, further comprising: signaling an error condition if the housing reflection exceeds a predetermined threshold.

19. The method of claim 14, further comprising: deriving a quadrature reference signal from the FMCW signal, which the mixer uses to produce a quadrature downconverted signal.

20. The method of claim 19, further comprising: applying a phase rotation to the downconverted signal and the quadrature downconverted signal to obtain an in-phase signal with a minimum phase noise or maximum DC component, and a quadrature phase signal with a maximum phase noise or minimum DC component.
